(19) United States
(12) Patent Application Publication
(10) Pub. No.: US 2024/0106943 A1
(43) Pub. Date: Mar. 28, 2024

(54) DISPLAY DEVICE THAT DISPLAYS OPERATION IMAGE, AND IMAGE FORMING APPARATUS

(71) Applicant: KYOCERA Document Solutions Inc., Osaka (JP)

(72) Inventor: Mitsuyuki KISHIMOTO, Osaka (JP)

(73) Assignee: KYOCERA Document Solutions Inc., Osaka (JP)

(21) Appl. No.: 18/369,489

(22) Filed: Sep. 18, 2023

(30) Foreign Application Priority Data
Sep. 28, 2022 (JP) 2022-154809

(51) Int. Cl. H04N 1/00

(52) U.S. Cl. CPC H04N 1/00517; H04N 1/00408; H04N 1/00506; H04N 1/00514

(57) ABSTRACT

A display device includes a panel, a power controller, and a controller. The panel includes a first region, to which power is supplied in a partial-screen mode including displaying an image only on a partial screen of the panel, and in a full-screen mode including displaying the image on an entire screen of the panel, and a second region to which the power is supplied, only in the full-screen mode. The power controller causes the panel to display the image, by supplying the power to the panel. The controller controls the panel and the power controller, to cause the first region to display the image, in the partial-screen mode, and acquires input information from the first region. In the full-screen mode, the controller causes the first region and the second region to display the image, and acquires the input information from the first region and the second region.

### INCORPORATION BY REFERENCE

This application claims priority to Japanese Patent Application No. 2022-154809 filed on Sep. 28, 2022, the entire contents of which are incorporated by reference herein.

### BACKGROUND

The present disclosure relates to a display device that displays an operation image, and an image forming apparatus.

Display devices that display an icon on the screen, and image forming apparatuses including such a display device, are widely known.

### SUMMARY

The disclosure proposes further improvement of the foregoing techniques.

In an aspect, the disclosure provides a display device including a panel and a control device. The panel displays an image, and outputs input information upon receipt of an input made on the image. The control device includes a processor, and acts as a power controller and a controller, when the processor executes a control program. The power controller causes the panel to display the image, by supplying power to the panel. The controller controls the panel and the power controller. The panel includes a first region, to which the power is supplied in a partial-screen mode including displaying the image only on a partial screen of the panel, and in a full-screen mode including displaying the image on an entire screen of the panel, and a second region to which the power is supplied in addition to the first region, only in the full-screen mode. The controller causes the first region to display the image in the partial-screen mode, acquires the input information outputted from the first region, causes the first region and the second region to display the image in the full-screen mode, and acquires the input information outputted from the first region and the second region.

In another aspect, the disclosure provides an image forming apparatus including the foregoing display device, and an image forming device. The image forming device forms an image on a recording medium.

### BRIEF DESCRIPTION OF THE DRAWINGS

FIG. 1 is a perspective view showing the appearance of an image forming apparatus according to an embodiment of the disclosure:

FIG. 2 is a block diagram showing a configuration of the display device;

FIG. 3 is a schematic drawing showing a panel composed of a combination of four panels:

FIG. 4 is a block diagram showing a configuration of the display device including the panel composed of the combination of four panels.

FIG. 5 is a schematic drawing showing an operation image displayed on the panel in a full-screen mode;

FIG. 6A is a graph showing a statistical result of the operation image, operated on the panel;

FIG. 6B is a schematic drawing showing the operation image selected on the basis of the statistical result of FIG. 6A, displayed in a partial image mode:

FIG. 7A is a graph showing a statistical result of the operation image operated on the panel, after a predetermined period has elapsed:

FIG. 7B is a schematic drawing showing the operation image selected on the basis of the statistical result of FIG. 7A, displayed in the partial image mode;

FIG. 8 is a flowchart for explaining a control process of the display device according to the embodiment; and

FIG. 9 is a flowchart for explaining a panel display control process, performed after statistical data is acquired and stored in the process of FIG. 8.

### DETAILED DESCRIPTION

Hereafter, an image forming apparatus according to an embodiment of the disclosure will be described, with reference to the drawings. In the drawings, the same or corresponding elements are given the same numeral, and the description of such elements will not be repeated.

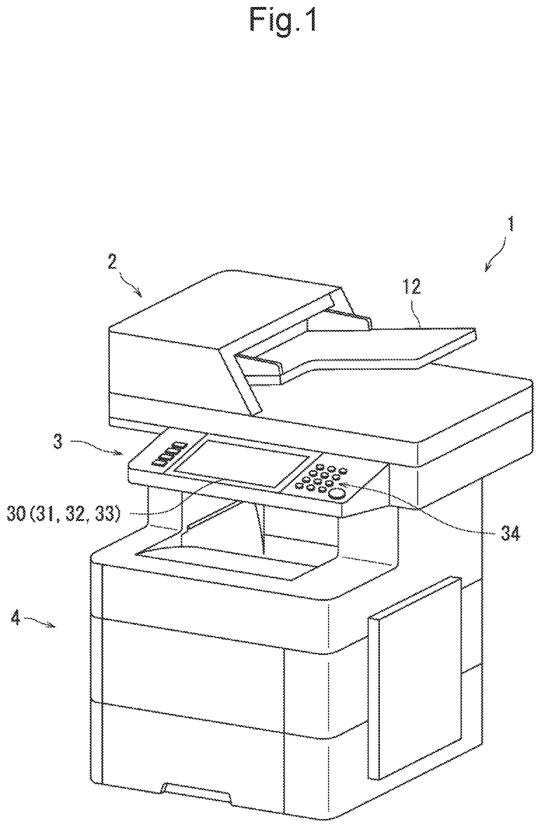

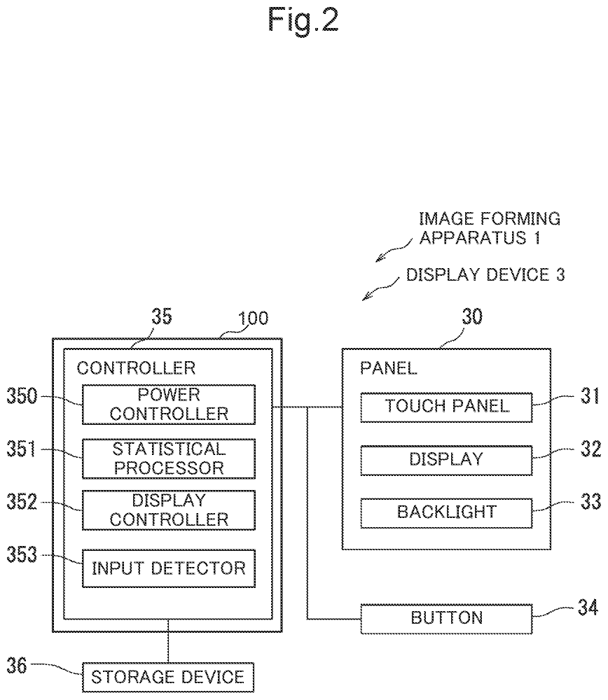

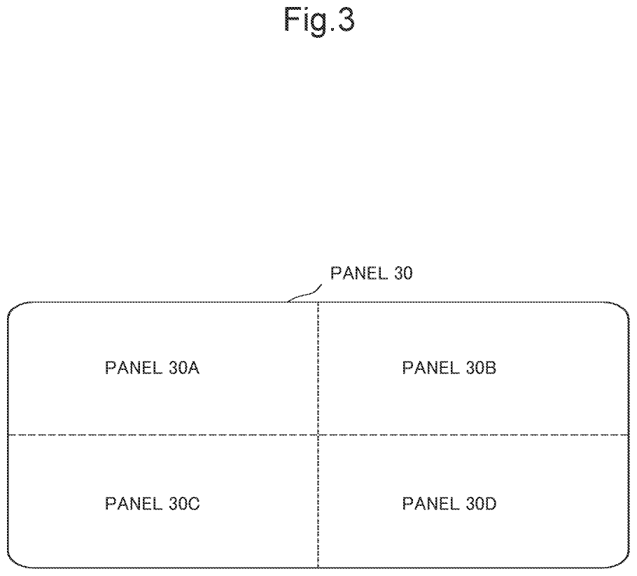

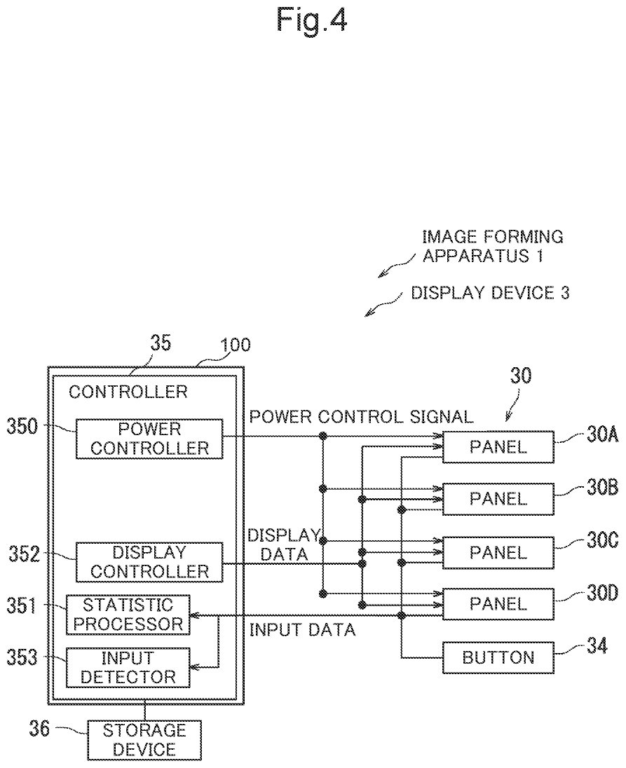

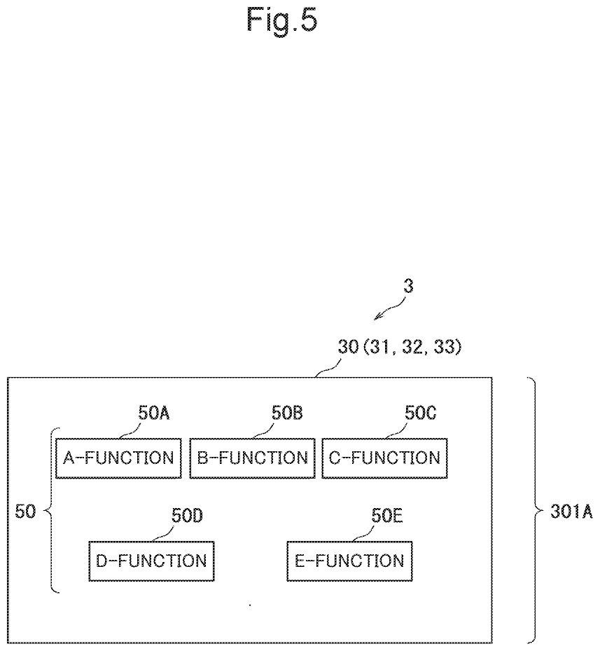

Referring first to FIG. 1 to FIG. 5, the image forming apparatus 1 will be described. FIG. 1 is a perspective view showing the appearance of the image forming apparatus 1 according to the embodiment of the disclosure. FIG. 2 is a block diagram showing a configuration of a display device 3. FIG. 3 is a schematic drawing showing a panel composed of a combination of four panels 30A, 30B, 30C, and 30D. FIG. 4 is a block diagram showing a configuration of the display device 3. FIG. 5 is a schematic drawing showing an operation image 50, displayed on the panel 30 in a full-screen mode.

As shown in FIG. 1, the image forming apparatus 1 includes a document reading device 2, a display device 3, and an image forming device 4.

The document reading device 2 includes an automatic document feeder (ADF), and a scanner. The document reading device 2 also includes a document tray 12. A non-illustrated source document placed on the document tray 12 is delivered to a non-illustrated document reading surface by a non-illustrated transport mechanism of the document reading device 2, and read by a non-illustrated image reading device, to be converted to image data.

The display device 3 includes a panel 30, buttons 34, a controller 35, and a storage device 36. The panel 30 includes a display 32, for example constituted of a liquid crystal display (LCD), a touch panel 31, and a backlight 33. The panel 30 serves to display an image, and receive an input to the image, to thereby output input information. To be more specific, the touch panel 31 of the panel 30 receives, on the basis of a user's operation performed on the image, the input to the image on which the user's operation has been performed, and outputs input information indicating an instruction corresponding to the operated image, to the controller 35. Examples of operation image 50 include a power button image, function tab images, button images, application images, short-cut images, and input frame images. The operation image 50 may be used to activate a function.

As described above, the panel 30 receives the user's operation, and outputs the input information. As shown in FIG. 3, the panel 30 may be composed of a combination of a panel 30A, a panel 30B, a panel 30C, and a panel 30D. In the panel 30, the panel 30A, the panel 30B, the panel 30C, and the panel 30D may be integrally formed. In the panel 30, the touch panel 31, the display 32, and the backlight 33 may be provided in a layered structure.

The touch panel 31 may be, for example, a projective capacitive screen. The touch panel 31, constituted of the projective capacitive screen, includes electrodes arranged in a matrix pattern, and the electrodes adjacent to each other are capacitively coupled. When a conductive object, such as a finger, comes close to the electrode, capacitive coupling takes place between the finger and the electrode, and the position where the capacitive coupling value between the electrodes has changed is detected as the touched position.

The display 32 is, for example, an organic electroluminescence (EL) display. The backlight 33 serves to illuminate the liquid crystal display from the back, in the case where the display 32 is not of a self-illuminating type.

The buttons 34 constitute a mechanical key group of the operation section. A numeral or a code is marked on each of the buttons 34. The user can instruct, for example, the number of sheets to be printed, by operating the buttons 34.

When the user operates the image displayed on the panel 30, the panel 30 outputs the input information, indicating the instruction corresponding to each of the images that has been operated, such as an image forming instruction, an image forming setting, a data transmission/reception instruction, a data transmission/reception setting, an image reading instruction, and an image reading setting, to the controller 35. In other words, the user can input the image forming instruction, the image forming setting, the data transmission/reception instruction, the data transmission/reception setting, the image reading instruction, and the image reading setting, by operating the images displayed on the panel 30.

The image forming device 4 includes a sheet feeding tray and an output tray. The image forming device 4 includes thereinside a non-illustrated printing mechanism, such as a sheet feeding mechanism, a sheet transport mechanism, a charging device, an exposure device, a developing device, a transfer device, a fixing device, and a delivery mechanism.

The sheet feeding tray can be drawn out from the casing of the image forming device 4, and the sheets stored in the sheet feeding tray are transported by the sheet feeding mechanism and the sheet transport mechanism. The sheet is developed with a developing agent such as toner, by the charging device, the exposure device, the developing device, and the transfer device, and transported to the fixing device. The developing agent such as the toner is fixed onto the sheet by the fixing device, after which the sheet is delivered to the output tray, by the delivery mechanism.

Referring now to FIG. 2, a control device 100 is a hardware circuit including a processor such as a central processing unit (CPU) and, for example, an application-specific integrated circuit (ASIC). The control device 100 acts as the controller 35, when the processor executes a control program stored, for example, in the storage device 36. The controller 35 controls all the functions of the image forming apparatus 1, and the operation of each of the components thereof, including the panel 30.

As shown in FIG. 2 and FIG. 4, the controller 35 includes a power controller 350, a statistical processor 351, a display controller 352, and an input detector 353. In other words, as shown in FIG. 4, the controller 35 acts as the power controller 350, the statistical processor 351, the display controller 352, and the input detector 353.

The power controller 350 supplies power for the panel 30 to display the images. To be more specific, the power controller 350 controls the power by outputting a power control signal to the panel 30A, the panel 30B, the panel 30C, the panel 30D, and the buttons 34.

The display controller 352 outputs display data, to the panel 30A, the panel 30B, the panel 30C, and the panel 30D.

The input detector 353 acquires input data, from the panel 30A, the panel 30B, the panel 30C, the panel 30D, and the button 34. The input detector 353 detects, upon acquiring the input data, the input made through the operation image on the panel 30, or the input made through the button 34. The input data is transmitted to the statistical processor 351.

The statistical processor 351 generates statistical data based on the input data, upon receipt of the input data from the panel 30 (30A, 30B, 30C, 30D) and the button 34. The statistical processor 351 performs the statistical processing, for example, about the operation images 50 touched on the panel 30, and outputs the statistical data. The statistical processor 351 performs the statistical processing about the operation images 50 touched on the panel 30, with respect to each of the users, and outputs such statistical data.

The statistical data is stored in the storage device 36.

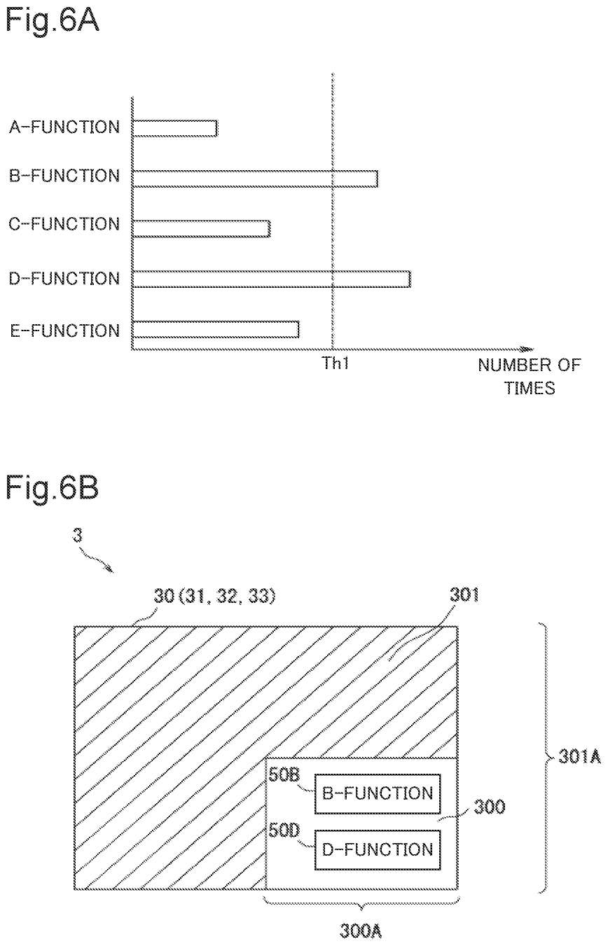

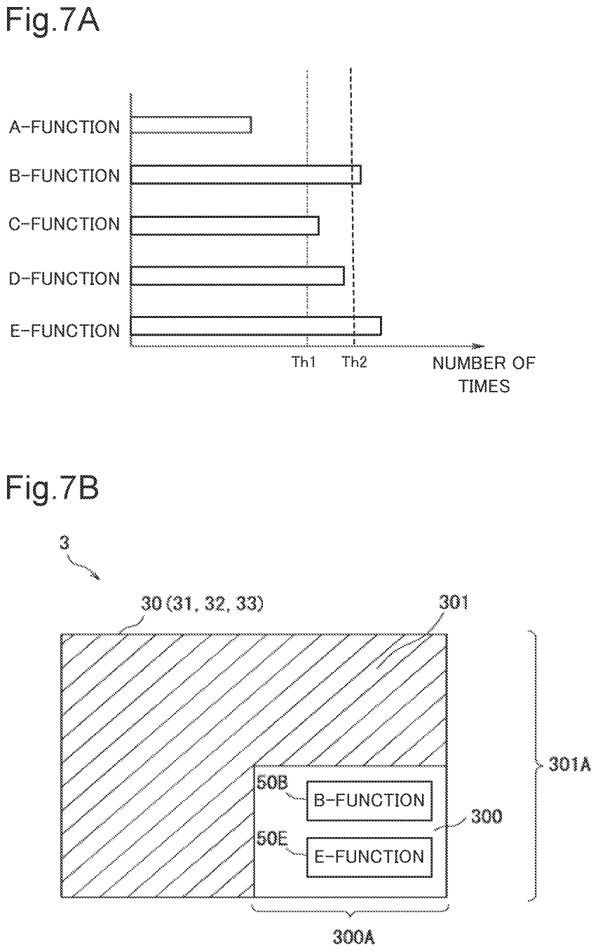

Referring further to FIG. 5, FIG. 6A, FIG. 6B, FIG. 7A, and FIG. 7B, in addition to FIG. 1 to FIG. 4, the control of the display device 3 according to this embodiment will be described in detail. FIG. 5 illustrates the display device 3 displaying the operation image 50 in the full-screen mode. FIG. 6A is a graph showing a statistical result of the operation image 50, operated on the panel 30. FIG. 6B illustrates the operation image selected on the basis of the statistical result of FIG. 6A, displayed in the partial image mode. FIG. 7A is a graph showing a statistical result of the operation image 50 operated on the panel 30, after a predetermined period has elapsed. FIG. 7B illustrates the operation image 50 selected on the basis of the statistical result of FIG. 7A, displayed in the partial image mode.

As shown in FIG. 5, FIG. 6B, and FIG. 7B, the panel 30 includes a first region 300A (panel 30D in FIG. 3), to which the power is supplied in a partial-screen mode including displaying the image only in a partial screen of the panel 30, and in a full-screen mode including displaying the image on the entirety of the panel 30, and a second region 301A (panel 30A, 30B, and 30C in FIG. 3) to which the power is supplied, in addition to the first region 300A, only in the full-screen mode including displaying the image on the entirety of the panel 30.

In the partial-screen mode, the controller 35 causes the first region 300A to display the image, and acquires the input information from the first region 300A. In the full-screen mode, the controller 35 causes the first region 300A and the second region 301A to display the image, and acquires the input information from the first region 300A and the second region 301A.

In the full-screen mode, for example, all of an operation image 50A for receiving the instruction to activate an A-function, an operation image 50B for receiving the instruction to activate a B-function, an operation image 50C for receiving the instruction to activate a C-function, an operation image 50D for receiving the instruction to activate a D-function, and an operation image 50E for receiving the instruction to activate an E-function may be displayed, as the operation image 50. To the A-function to the E-function, for example, a copying function, a printing function, a facsimile function, a scanning function, a telephone function or other functions may be respectively assigned as desired.

In the full-screen mode, the operation image 50A, the operation image 50B, the operation image 50C, the operation image 50D, and the operation image 50E may be generally evenly located, in the second region 301A of the panel 30.

The controller 35 may switch between the partial-screen mode shown in FIG. 6B and FIG. 7B, and the full-screen mode shown in FIG. 5, on the basis of the input information. In other words, the panel 30 receives the input of the instruction to switch between the partial-screen mode and the full-screen mode, through the touch panel 31, according to the operation performed on the image displayed on the panel 30, and outputs the input information indicating such instruction to the controller 35. The controller 35 switches between the partial-screen mode and the full-screen mode of the panel 30, according to the input information.

As shown in FIG. 6B and FIG. 7B, the controller 35 may display a part of the operation image 50 on the panel 30, in the partial-screen mode.

In this embodiment, operability for the user can be improved, by displaying only a part of the operation image 50 on a part of the panel 30, thereby facilitating a frequently used function to be activated.

The controller 35 may select the operation image 50 to be displayed in the partial-screen mode, on the basis of the statistical data, and cause the first region 300A to display only the operation image 50 that has been selected, in the partial-screen mode.

The controller 35 may select the operation image 50 to be displayed in the partial-screen mode, on the basis of the statistical data, with respect to each of the users.

The controller 35 may cause the panel 30 to display only the selected operation image 50 in the partial-screen mode, with respect to each of the users.

To be more specific, as shown in FIG. 6A, the statistical processor 351 counts the number of times that each of the operation images representing the A-function to E-function shown in FIG. 5 has been touched, with respect to a given user. The statistical processor 351 distinguishes the users on the basis of user ID information, inputted when the user logs in in the image forming apparatus 1.

In the example shown in FIG. 6A, the user selected the D-function with the highest frequency, and the B-function with the second highest frequency.

In view of such statistical result, the statistical processor 351 outputs the statistical data indicating that only the B-function and the D-function were more frequently selected than a frequency threshold T h.

In this case, as shown in FIG. 6B, the display controller 352 of the controller 35 lights up the backlight 33 (see FIG. 2) only for a partial screen 300 (panel 30D in FIG. 3) of the panel 30, according to the user's instruction, and causes only the partial screen 300 (panel 30D in FIG. 3) to display the operation image 50B representing the B-function, and the operation image 50D representing the D-function, according to the statistical data.

With the arrangement according to this embodiment, the operation image 50 is displayed only on the partial screen 300 (panel 30D in FIG. 3) according to the statistical data, and therefore the operability for the user can be improved. This is because, compared with the case where the operation images 50 are displayed over the entirety of the panel 30, displaying the operation images 50 only in a part of the panel 30 limits the visual recognition range and the operation range for the user, which contributes to improving the operability.

According to this embodiment, acquiring the statistical data with respect to each of the users, and displaying only the frequently selected operation images 50, on the partial screen 300 (panel 30D in FIG. 3) only, contributes to improving the operability for the user. In other words, the operation images 50 more likely to be selected by the user are displayed, while the operation images 50 less likely to be selected are not displayed. Such an arrangement facilitates the user to find out the desired operation image 50, thereby further improving the operability for the user.

Referring to FIG. 7A, the statistical processor 351 may count the number of times of instruction with respect to each of the operation images 50, determine a threshold W and revise the threshold Th1 to a threshold Th2, such that the number of the operation images 50, the number of times of instruction of which has exceeded the threshold Th1, stays within a predetermined range.

To be more specific, the statistical processor 351 counts, successively from FIG. 6A, the number of times of instruction of each of the operation images 50, as shown in FIG. 7A.

In FIG. 6A, only the B-function and the D-function were selected with higher frequency than the threshold Th1. Here, it will be assumed that, thereafter, the number of times of instruction of the B-function, the C-function, the D-function, and the E-function increased, until the number of times of instruction of these functions exceeded the threshold Th1, as shown in FIG. 7A.

In this case, the statistical processor 351 revises the threshold Th1 to the threshold Th2, such that the number of times of instruction of only the B-function and the E-function exceeds the threshold Th, as shown in FIG. 7A.

Such an arrangement according to this embodiment enables the number of the operation images 50 to be displayed on the partial screen 300 to be limited, thereby further improving the operability for the user.

As shown in FIG. 7B, the controller 35 may change the operation images 50 to be displayed on the panel 30, depending on the transition of the statistical data.

As shown in FIG. 7B, display controller 352 of the controller 35 lights up the backlight 33 (see FIG. 2) only for the partial screen 300 of the panel 30, according to the user's instruction, and causes only the partial screen 300 to display the operation image 50B representing the B-function, and the operation image 50E representing the E-function, according to the statistical data.

According to this embodiment, as described above, the operation images 50 to be displayed on the partial screen 300 (panel 30D in FIG. 3) can be changed, on the basis of the transition with time of the number of times of instruction of the functions.

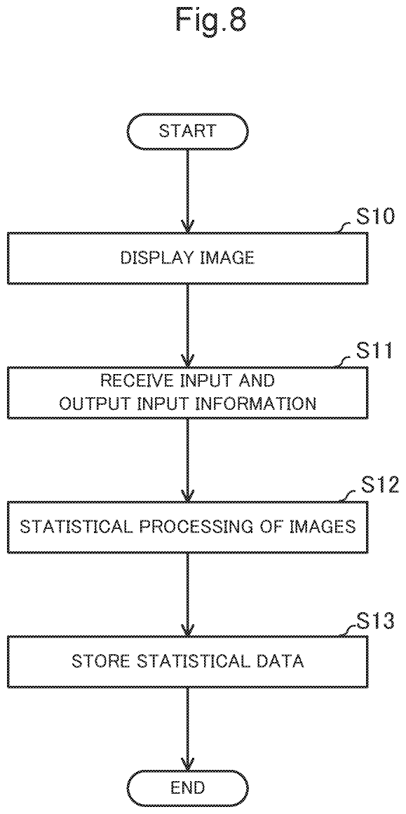

Referring now to FIG. 8, the control performed by the display device 3 according to this embodiment will be described hereunder. FIG. 8 is a flowchart for explaining the control of the display device 3 according to this embodiment.

At step S10 in FIG. 8, the panel 30 displays the image. Then the operation proceeds to step S11. At step S11, when the operation image 50 is touched, the panel 30 receives the input through the touch panel 31, and outputs the input information indicating the instruction corresponding to the image that has been touched. Then the operation proceeds to step S12. At step S12, the statistical processor 351 performs the statistical processing about the operation images 50 touched on the panel 30, and outputs the statistical data. Then the operation proceeds to step S13. At step S13, the statistical data is stored in the storage device 36. At this point, the operation is finished.

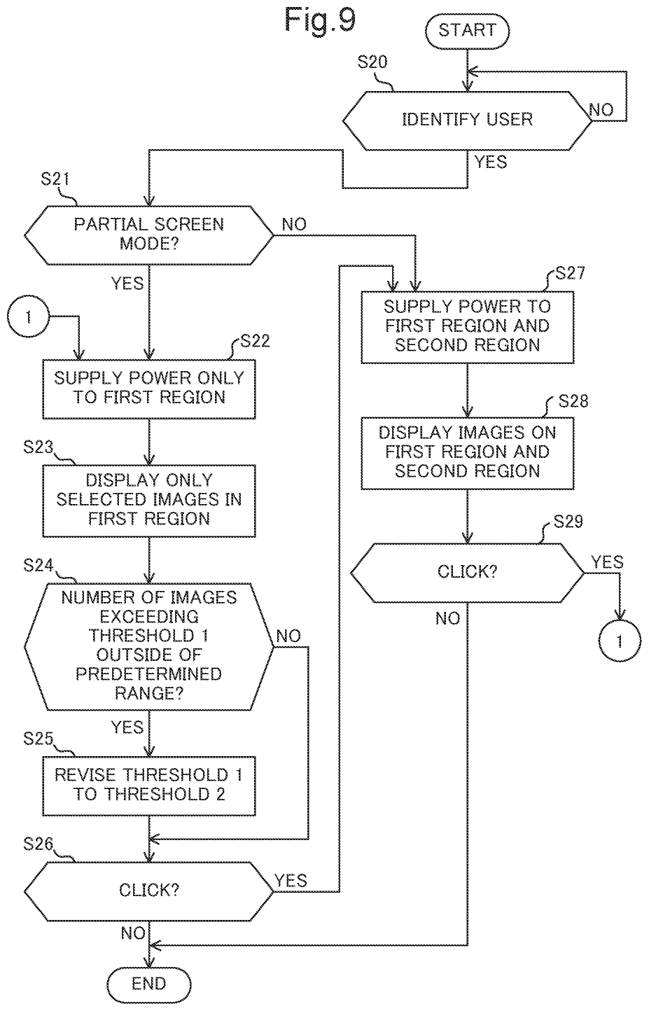

Referring now to FIG. 9, the control performed by the display device 3 according to this embodiment w % ill be further described. FIG. 9 is a flowchart for explaining the display control of the panel 30, performed after the statistical data is acquired and stored in FIG. 8.

At step S20 in FIG. 9, when the user inputs the ID information using the panel 30 or the buttons 34, and the controller 35 decides that the ID information that has been inputted is a legitimate one, the user corresponding to the ID information is permitted to log in. The input data is transmitted to the input detector 353 (see FIG. 4) and the statistical processor 351. Then the operation proceeds to step S21. At step S21, the input detector 353 detects whether the user has instructed to set the partial-screen mode. When the partial-screen mode is instructed (Yes at step S21), the operation proceeds to step S22. In the case where the partial-screen mode has not been instructed (No at step S21), the operation proceeds to step S27.

When the partial-screen mode is instructed (Yes at S21), the power controller 350 supplies the power only to the first region 300A of the panel 30, at step S22. Then the operation proceeds to step S23.

At step S23, the display controller 352 causes the first region 300A, corresponding to the panel 30D, to display only the operation image 50B and the operation image 50D that have been selected. Then the operation proceeds to step S24.

At step S24, the statistical processor 351 (controller 35) decides whether the number of operation images 50 that have exceeded the threshold TI is outside of a predetermined range. When the number of operation images 50 that have exceeded the threshold Th1 is outside of the predetermined range (Yes at step S24), the operation proceeds to step S25. When the number of operation images 50 that have exceeded the threshold Th1 is not outside of the predetermined range (No at step S24), the operation proceeds to step S26.

When the number of operation images 50 that have exceeded the threshold Th1 is outside of the predetermined range (Yes at step S24), the statistical processor 351 revises the threshold Th from the threshold Th1 to the threshold Th2, such that the number of operation images 50 that have exceeded the threshold Th1 enters the predetermined range, at step S25. Then the operation proceeds to step S26.

The input detector 353 detects whether the user has clicked on the panel 30, on the basis of the output signal transmitted from the touch panel 31. Instead, the input detector 353 may detect whether the user has touched, pressed long, swiped, dragged, pinched in, pinched out, flicked, or scrolled, on the panel 30.

In the case where the clicking action of the user on the panel 30 is not detected (No at step S26), the operation is finished. When the clicking action of the user on the panel 30 is detected (Yes at step S26), the operation proceeds to step S27.

When the clicking action of the user on the panel 30 is detected (Yes at step S26), and when the partial-screen mode has not been instructed by the user (No at step S21), the power controller 350 supplies the power to the entire screen 301 (first region 300A and second region 301A) of the panel 30, at step S27. In other words, when the controller 35 receives, while the first region is displayed on the panel 30, the input information indicating that the user has performed an operation on a part of the screen of the panel, instead of the input information indicating the instruction to switch to the partial-screen mode, based on the operation performed on the operation image, the controller 35 displays the operation images, in the full-screen mode. Thereafter, the operation proceeds to step S28.

At step S28, the display controller 352 causes the entire screen 301 (first region 300A and second region 301A) of the panel 30 to display the operation images 50. Then the operation proceeds to step S29.

At step S29, the input detector 353 detects whether the user has clicked on the panel 30. Instead, the input detector 353 may detect whether the user has touched, pressed long, swiped, dragged, pinched in, pinched out, flicked, or scrolled, on the panel 30.

When the clicking action of the user on the panel 30 is detected (Yes at step S29), the operation returns to step S22. In the case where the clicking action of the user on the panel 30 is not detected (No at step S29), the operation is finished.

Here, the existing display devices are not configured to change the display position of icons on the screen, according to the selection frequency of the icons. According to this embodiment, in contrast, only some of the operation images, for activating the most frequently used functions, are displayed on a part of the panel, which leads to improved operability for the user.

The disclosure may be modified in various manners, without limitation to the configuration according to the foregoing embodiment. Further, the configurations and processings of the first and second embodiments, described with reference to FIG. 1 to FIG. 9, are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. A display device comprising:
a panel that displays an image, and outputs input information on a basis of an operation performed on the image, upon receipt of an input made on the image by the operation; and
a control device including a processor, and configured to act, when the processor executes a control program, as:
a power controller that causes the panel to display the image, by supplying power to the panel; and
a controller that controls the panel and the power controller,
wherein the panel includes:
a first region, to which the power is supplied in a partial-screen mode including displaying the image only on a partial screen of the panel, and in a full-screen mode including displaying the image on an entire screen of the panel; and
a second region to which the power is supplied in addition to the first region, only in the full-screen mode, and
the controller is configured to:
cause the first region to display the image in the partial-screen mode;
acquire the input information outputted from the first region;
cause the first region and the second region to display the image in the full-screen mode; and
acquire the input information outputted from the first region and the second region.

2. The display device according to claim 1,
wherein the image includes an operation image for receiving an instruction on a basis of an operation,
the control device further acts, when the processor executes the control program, as a statistical processor that performs statistical processing of the operation image instructed through the panel, and outputs statistical data,
the display device further comprising a storage device for storing the statistical data, and
the controller selects the operation image to be displayed in the partial-screen mode, on a basis of the statistical data, and causes the first region to display only the operation image that has been selected, in the partial-screen mode.

3. The display device according to claim 1,
wherein the image includes an operation image for receiving an instruction on a basis of an operation,
the control device further acts, when the processor executes the control program, as a statistical processor that performs statistical processing of the operation image instructed through the panel, and outputs statistical data, with respect to each user,
the display device further comprising a storage device for storing the statistical data, and
the controller selects the operation image to be displayed in the partial-screen mode, on a basis of the statistical data with respect to each user, and causes the panel to display only the operation image that has been selected, in the partial-screen mode, with respect to each user.

4. The display device according to claim 3,
wherein the statistical processor counts a number of times of instruction of each of a plurality of the operation images, sets a threshold, and revises the threshold such that a number of the operation images, the number of times of instruction of which has exceeded the threshold, becomes within a predetermined range.

5. The display device according to claim 3,
wherein the controller changes the image to be displayed on the panel, each time the statistical data is changed.

6. The display device according to claim 1,
wherein the panel receives an instruction to switch between the partial-screen mode and the full-screen mode, on a basis of the operation performed on the image, and outputs the input information indicating the instruction, to the controller, and
the controller switches the display on the panel in accordance with the input information, between the partial-screen mode and the full-screen mode.

7. The display device according to claim 6,
wherein, when the controller receives, while the first region is displayed on the panel, the input information indicating that the user has performed an operation on a part of the screen of the panel, instead of the input information indicating the instruction to switch to the partial-screen mode, based on the operation performed on the image, the controller displays the operation image, in the full-screen mode.

8. An image forming apparatus comprising:
the display device according to claim 1; and
an image forming device that forms an image on a recording medium.
